(19) United States
(12) Patent Application Publication
(10) Pub. No.: US 2026/0134463 A1
(43) Pub. Date: May 14, 2026

(54) REAL-TIME OFFER NEGOTIATION ASSISTANCE

(71) Applicant: MFTB Holdco, Inc., Seattle, WA (US)

(72) Inventors: Aveek Karmakar, Issaquah, WA (US); Reid Johnson, Seattle, WA (US); Stanley B. Humphries, Sammamish, WA (US); Aaron Wroblewski, Seattle, WA (US); Leslie Ferguson, Seattle, WA (US); Matthew Fix, Seattle, WA (US); William Froelich, Burbank, CA (US)

(21) Appl. No.: 18/943,516

(22) Filed: Nov. 11, 2024

(51) Int. Cl. G06Q 30/0601; G06Q 50/16

(52) U.S. Cl. CPC G06Q 30/0611; G06Q 50/16

(57) ABSTRACT

Real-time offer negotiation assistance is provided. In examples, an offer negotiation engine receives a proposed offer from a user. An offer grading model trained on historical data regarding listings, offers, and sales of homes evaluates the proposed offer and generates an offer grade. An offer guidance generator generates guidance for the proposed offer, such as recommendations to improve the proposed offer. In further examples, the offer negotiation engine receives an offer prompt from the user. An offer generation model trained on the historical data generates a proposed offer based on the offer prompt.

### BACKGROUND

Offers to purchase homes include many complex terms and intricate details that make it difficult for potential buyers to draft an offer. Potential buyers may have a goal in mind—such as preparing a competitive offer—but may not know how to prepare an offer to meet their goals. In some cases, a potential buyer may have an agent prepare an offer. However, this can be expensive and time consuming, and taking too long to prepare an offer may lead to the home being sold to another buyer before the offer is even presented to the seller.

Additionally, even if a potential buyer is able to put together an offer, they may not be able to evaluate whether the offer is competitive. While potential buyers may have an agent evaluate a proposed offer, human evaluation of the proposed offer takes time. As with preparing the offer, if evaluating the offer takes too long, the potential buyer could miss an opportunity to propose the offer to the seller as the seller may sell the home to a different buyer. Automated offer evaluators may be able to quickly evaluate an offer but may sacrifice on accuracy. If an evaluation is inaccurate, the potential buyer could end up paying too much or could miss out on the home because the offer was not as good as expected and was rejected by the seller. Additionally, with automated offer evaluators, potential buyers may have questions about the proposed offer or the evaluation that cannot be answered by the automated system.

### SUMMARY

In general terms, this disclosure is directed to real-time offer negotiation. In some embodiments, and by non-limiting example, an offer negotiation engine receives a proposed offer from a user. An offer grading model trained on historical data regarding listings, offers, and sales of homes evaluates the proposed offer and generates an offer grade. An offer guidance generator generates guidance for the proposed offer, such as recommendations to improve the proposed offer. In additional embodiments, and by non-limiting example, the offer negotiation engine receives an offer prompt from a user and generates a proposed offer for the user based on the offer prompt. An offer generation model trained on historical data regarding listings, offers, and sales of homes generates the proposed offer.

In a first aspect, a method for evaluating an offer to purchase a home is provided. An offer grading model is trained based on historical data. The historical data includes listing data, offer data, and sale data. A proposed offer including at least one term of an offer to purchase a home is received. The proposed offer is input via a user interface presented at a computing device. In response to receiving the proposed offer, an offer grade is generated, guidance on the proposed offer is generated, and the user interface presented at the computing device is caused to present the offer grade and the generated guidance. The offer grade is generated based on the proposed offer using the trained offer grading model. The guidance is generated based on the offer grade and the proposed offer.

In a second aspect, a system for evaluating an offer to purchase a home is provided. The system includes one or more processors and one or more computer-readable storage devices storing data instructions. The data instructions, when executed by the one or more processors, cause the system to train an offer grading model, receive a proposed offer, and in response to receiving the proposed offer, generate an offer grade based on the proposed offer, generate guidance on the proposed offer, and cause a user interface presented at a computing device to present the offer grade and the generated guidance. The offer grading model is trained based on historical data including listing data, offer data, and sale data. The proposed offer includes at least one term of an offer to purchase a home and is input via the user interface presented at the computing device. The offer grade is generated using the trained offer grading model. The guidance is generated based on the offer grade and the proposed offer.

In a third aspect, a method for evaluating an offer to purchase a home is provided. An input defining an offer to purchase a home is received. The offer includes one or more terms. The offer is transmitted to an offer negotiation server. The offer negotiation server includes a trained offer grading model and an offer guidance generator. The offer grading model is trained based on historical data including listing data, offer data, and sale data. An offer grade and guidance associated with the offer are received from the offer negotiation server. The offer grade is determined by the offer grading model based on the one or more terms. The guidance is generated by the offer guidance generator. The offer grade and the guidance are presented via a user interface.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates a system for providing offer negotiation assistance.

FIG. 2 illustrates an example embodiment of a system for providing offer grades and guidance.

FIG. 3 illustrates an example message flow diagram for providing offer grades and guidance.

FIG. 4 illustrates an example system for generating guidance for a proposed offer based on seller feedback.

FIG. 5 illustrates an example system for grading and providing guidance on a revised offer.

FIG. 6 illustrates an example message flow diagram for providing guidance for an initial proposed offer based on feedback from a seller and grading a revised offer.

FIG. 7 illustrates an example offer creation user interface.

FIG. 8 illustrates an example offer guidance user interface.

FIG. 9 illustrates an example offer revision user interface.

FIG. 10 illustrates a flowchart of an example method for evaluating an offer to purchase a home.

FIG. 11 illustrates a flowchart of an example method for presenting an offer grade and offer guidance to a user.

FIG. 12 illustrates an example system for generating a proposed offer.

FIG. 13 illustrates an example offer prompt user interface.

FIG. 14 illustrates an example generated offer user interface.

FIG. 15 illustrates a flowchart of an example method for generating a proposed offer.

FIG. 16 illustrates an example computing device on which aspects of the present disclosure may be implemented.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

As briefly described above, the present disclosure relates to real-time offer negotiation assistance. While examples disclosed herein describe offer negotiation assistance for offers to purchase homes, the scope of the present disclosure is not limited thereto; in alternative examples, the present disclosure may be applied to negotiation assistance for any offers, including offers to purchase or lease real estate properties (e.g., homes, apartments, and office spaces). Similarly, while examples described herein may describe a user as a potential buyer of a home, in alternative examples, the user may be a seller or an agent of the potential buyer or the seller.

In example embodiments, a user may submit an offer to purchase a home to an offer negotiation engine. The offer negotiation engine can evaluate the offer to determine a strength of the offer, which may be based on a calculated probability that the offer would be accepted. In an example, the offer negotiation engine may include an offer grading model that is trained on historical data to determine the probability that the offer would be accepted. For example, the historical data may include data on previous listings for homes, offers made to purchase the homes, and the final sales of the homes. By training the offer grading model on the historical data, the offer grading model can provide accurate estimates of the probability that an offer would be accepted. In an embodiment, the offer grading model is trained on a periodic schedule (e.g., daily). Accordingly, the offer grading model is already trained when it receives an offer to grade. This allows the offer grading model to quickly evaluate the offer and determine a grade for the offer.

In some examples, the offer negotiation engine further includes an offer guidance generator, which provides guidance to the user based on the offer grade. For example, the offer guidance generator may provide a reasoning for the offer grade and provide recommendations to improve the offer, which may include recommendations to increase the strength of the offer or recommendations to make the offer better for the user. In examples, the offer guidance generator further allows the user to ask questions regarding the offer grade and guidance and provides response to the questions, helping the user to better understand the offer and the included terms.

In additional example embodiments, a user may submit an offer prompt to the offer negotiation engine. The offer negotiation engine may generate a proposed offer based on the offer prompt. In examples, the offer prompt may include criteria on which the offer negotiation generates the proposed offer. For example, the offer prompt may include a request for a strong offer, and the offer negotiation engine may generate a proposed offer that maximizes an estimated probability of acceptance of the proposed offer. In embodiments, the offer negotiation engine includes an offer generation model that is trained on historical data, such as data on previous listings for homes, offers made to purchase the homes, and the final sales of the homes. Like with the offer grading model, the offer generation model may be trained on a periodic schedule (e.g., daily), allowing the offer generation model to quickly generate proposed offers when offer prompts are received.

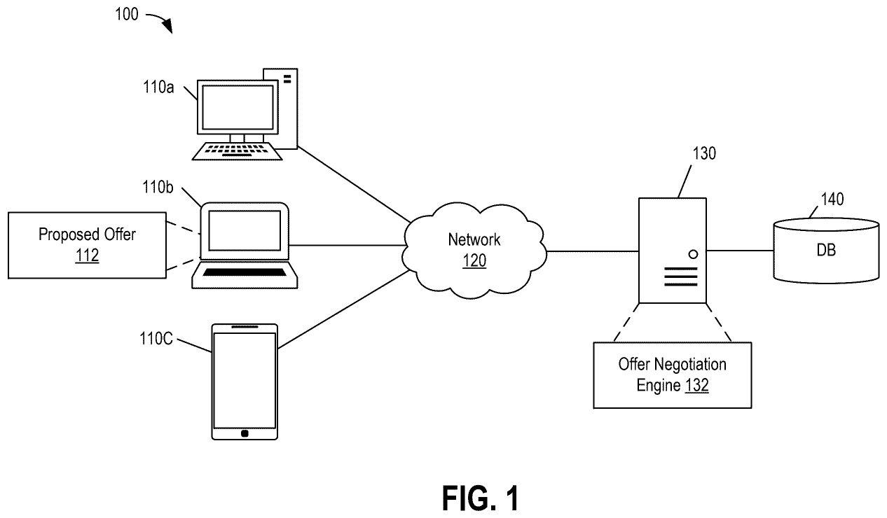

Turning now to FIG. 1, a system 100 for providing offer negotiation assistance is shown. In the illustrated example, the system 100 includes one or more user computing devices 110 connected to an offer negotiation server 130 over a network 120, such as the Internet.

In an embodiment, the offer negotiation server 130 is an edge server which receives requests from users and coordinates fulfillment of those requests through other servers (not shown). Similarly, while one offer negotiation server 130 is shown, there may be a plurality of offer negotiation servers 130. In the illustrated embodiment, the offer negotiation server 130 includes an offer negotiation engine 132. As described further herein, when a proposed offer 112 is received from a user computing device 110, the offer negotiation engine 132 evaluates the proposed offer 112 and provides an offer grade and guidance to the user. For example, the guidance may include recommendations to improve the proposed offer 112. In other examples, as described further herein, the offer negotiation engine 132 may receive an offer prompt and generate a proposed offer 112 based on the offer prompt.

In the illustrated embodiment, the offer negotiation server 130 is connected to a database 140. As described further herein, the database 140 may store historical data used by the offer negotiation engine 132 to evaluate the proposed offer 112 (or generate the proposed offer 112). While the illustrated embodiment shows one database 140, in alternative embodiments, the offer negotiation server 130 may connect to multiple databases 140.

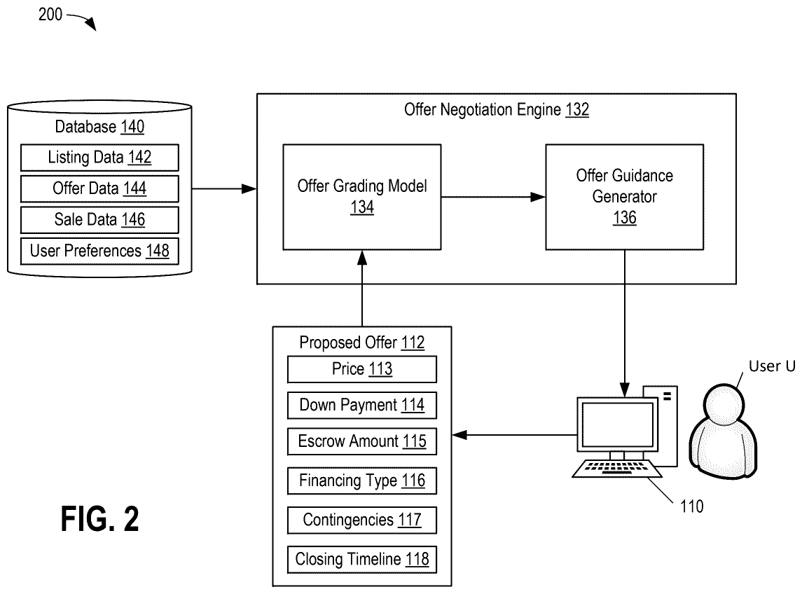

FIGS. 2-11 illustrate example embodiments for evaluating proposed offers. FIG. 2 illustrates an example embodiment of a system 200 for providing offer grades and guidance. In the illustrated embodiment, a user U submits a proposed offer 112 to an offer negotiation engine 132 from a computing device 110.

In an embodiment, the user U inputs information associated with the proposed offer 112 into the computing device 110. In an example, the computing device 110 may be executing a real estate application or may be connected to a real estate website operating on a server (such as the server 130 described above in connection with FIG. 1). In embodiments, the user U can manually enter information associated with the proposed offer 112, such as terms of the proposed offer 112, into a user interface on the computing device 110. In an alternative embodiment, the user U may upload a document including the proposed offer 112, and the terms of the proposed offer 112 may automatically be extracted from the document.

In the illustrated embodiment, the proposed offer 112 includes an offer price 113, a down payment 114, an escrow amount 115, a financing type 116, one or more contingencies 117, and a closing timeline 118. In other examples, the proposed offer 112 may include additional or alternative terms such as an expiration date of the proposed offer 112, an amount of earnest money, financing terms, warranties, proof of funds, and a pre-approval amount. It is understood that the information that can be associated with a proposed offer 112 is not limited to the examples described herein and may include additional or alternative terms or information.

The proposed offer 112 is transmitted from the computing device 110 to the offer negotiation engine 132, which grades the proposed offer 112 and provides guidance to the user U regarding the proposed offer 112. In an example, the offer negotiation engine 132 operates on an offer negotiation server, such as described above in connection with FIG. 1. In the illustrated embodiment, the offer negotiation engine 132 includes an offer grading model 134 and an offer guidance generator 136.

The offer grading model 134 evaluates the proposed offer 112 and generates a grade for the proposed offer 112. In an example, the offer grading model 134 estimates a probability that the proposed offer 112 would be accepted, and the grade output by the offer grading model 134 is based on the estimated probability. In an example, the offer grading model 134 may use predetermined mappings between probabilities and grades to determine the offer grade. For example, if the offer grading model 134 calculates that the proposed offer 112 has a low probability to be accepted (e.g. less than 40%), then the offer grading model 134 may determine that the grade for the proposed offer 112 is “risky.” If the offer grading model 134 calculates that the proposed offer 112 has a moderate probability to be accepted (e.g., between 40% and 60%), the offer grading model 134 may determine that the grade for the proposed offer 112 is “competitive.” If the offer grading model 134 calculates that the proposed offer 112 has a high probability to be accepted (e.g., above 60%), the offer grading model 134 may determine that the grade for the proposed offer 112 is “strong.” In alternative embodiments, additional or alternative mappings between probabilities and grades may be used by the offer grading model 134. In some embodiments, the probability of acceptance may be decomposed into predefined outcomes. For example, the probability of acceptance may be decomposed into outcomes including the offer being accepted, being outbid by another potential buyer, and having the offer rejected. By decomposing the probability into the predetermined outcomes, additional information may be provided to the offer guidance generator to generate more insightful guidance related to the proposed offer, as described further herein.

In an embodiment, the offer grading model 134 is trained using historical data, such as listing data 142, offer data 144, and sale data 146 from past transactions involving homes. In an embodiment, the listing data 142 includes data regarding homes that were listed for sale, such as the listing price. The offer data 144 may include data regarding offers to purchase the homes that were listed for sale. The sale data 146 may include data regarding the sales of the homes that were listed for sale, such as the terms of the offers that were accepted. In an embodiment, the historical data—i.e., the listing data 142, the offer data 144, and the sale data 146—is maintained in a database 140. In an example, the database 140 is maintained at a server, such as the offer negotiation server 130 described above in connection with FIG. 1.

In an example, the offer grading model 134 includes a plurality of sub-models —for example, models trained for specific geographical locations or types of homes. For example, the offer grading model 134 may include a model trained for a specific city. In this example, the model may be trained using historical data associated with the city. Similarly, in some examples, historical data from a predetermined time period (e.g., the previous year) is used to train the offer grading model 134.

In an example embodiment, the offer grading model 134 includes a Monte Carlo model that estimates the probability that the proposed offer 112 would be accepted. In an example, training the Monte Carlo model includes determining distributions for one or more input variables for a Monte Carlo simulation. For example, the distributions may be determined based on sampling from historical data—i.e., listing data 142, offer data 144, and sale data 146. In some embodiments, the distributions may be assumed to be Gaussian distributions, and the mean and standard deviations of the distributions are determined based on the historical data. In alternative embodiments, other distributions may be used. For example, for a rate of acceptance variable in the Monte Carlo simulation, a Bernoulli distribution may be used. In further examples, inputs to the Monte Carlo model may further include estimated statistics associated with the subject home, such as an estimated quantile of the sale price of the subject home and an estimated time until the subject home is sold. In examples, one or more of the estimated statistics may be generated by a trained model, such as a machine learning model or a statistical model, using the historical data. In an embodiment, the trained model may include an automated valuation model.

Once the offer grading model 134 is trained, the offer grading model 134 can evaluate the proposed offer 112 to determine the offer grade. In an example, the offer grading model 134 considers the terms of the proposed offer 112 (e.g., the offer price 113, the down payment 114, the escrow amount 115, the financing type 116, the one or more contingencies 117, and the closing timeline 118, in the illustrated example) to determine the grade. The offer grading model 134 may also consider listing data 142 for the home to which the proposed offer applies. In an embodiment, the offer grading model 134 determines an estimated value of the home to use in the evaluation of the proposed offer 112. In an example, the estimated value of the home is based on listing data 142 and sale data 146 for similar homes (e.g., homes in the same geographical area).

In example implementations, the offer grading model 134 may, when trained, receive the offer terms in the proposed offer 112 and generate a score in response thereto. In some cases, the score may be a single score, or may include a plurality of sub-scores indicative of strength of each term of the offer. The overall score may be compared to a plurality of scoring thresholds to determine an offer grade—e.g., “strong”, “moderate”, “risky”, “unlikely successful” and the like. Additionally, each sub-score may be compared to sub-scores of other successful offers to determine a percentage deviation of the sub-score; such deviations may be used in determining a controlling factor driving the offer grade, which may be provided as feedback to the user U.

The offer guidance generator 136 may use the offer grade generated by the offer grading model 134 to provide guidance to the user U about the proposed offer 112. Other information may be considered by the offer guidance generator 136 as well, including the historical data used by the offer grading model (i.e., the listing data 142, the offer data 144, and the sale data 146) as well as user preferences 148. In an example, the guidance provided to the user U includes a reasoning for the offer grade and recommendations to improve the proposed offer 112. For example, if the offer grade is “risky” and the offer price 113 was determined by the offer grading model to be a leading factor in the evaluation, the offer guidance generator 136 may generate feedback indicating that the offer price 113 is lower than in comparable sales and recommend the user U increase the offer price 113. In some examples, the guidance generated by the offer guidance generator 136 may be based on the probability of acceptance generated by the offer grading model 134. For example, in some embodiments, as described above, the probability of acceptance may be decomposed into predefined outcomes (e.g., having the offer accepted, being outbid, and having the offer rejected). The offer guidance generator 136 may consider these outcomes when generating guidance for the user.

The user preferences 148 may affect the recommendations made by the offer guidance generator 136. For example, the user preferences 148 may include a stated budget for the user U. In this example, the offer guidance generator 136 may account for the budget when making recommendations regarding the proposed offer 112. For example, the offer guidance generator 136 may not recommend raising the offer price 113 above the stated budget. In another example, the offer guidance generator 136 may recommend including an inspection contingency 117 in the proposed offer 112 as waiving the inspection contingency 117 would likely cause the cost of insurance for the home to increase the overall cost of the home above the user's U stated budget. In an embodiment, the user preferences 148 are manually entered by the user U. In an alternative embodiment, the user preferences 148 are learned over time by the offer negotiation engine 132. In an example, the user preferences 148 may be learned based on the listings that are viewed by the user U, or other user interactions. For example, if the user U does not look at listings with asking prices above $1,000,000, or if the user U often sets a filter on listings having a maximum price of $1,000,000, the budget for the user U may be inferred to be $1,000,000.

In an embodiment, the offer guidance generator 136 includes a large language model (LLM) configured to process the offer grade and other information from the offer grading model 134 to output a text-based assessment of the proposed offer 112. In such an instance, the large language model may be provided with the offer grade, as well as predetermined prompting information including the leading factors in determining the offer grade, a stated or inferred budget, prompting to request a particularized, user-specific tone and expected output content, and a request for suggestions for offer improvement based on the offer grade, factors, and budget, as well as risk factors associated with offer terms. Other types of prompts may be included as well, for example to personalize the response from the LLM.

In an alternative embodiment, offer guidance generator 136 uses a predetermined set of rules to generate the text-based assessment of the proposed offer 112. For example, a rule may define that the offer guidance generator include text explaining the likely increase in acceptability of an offer if an inspection contingency is waived, and also may include guidance regarding the risk in waiving an inspection contingency if the proposed offer 112 includes a waiver of the inspection contingency 117.

In embodiments, the offer grade and the guidance are presented to the user U via a user interface at the computing device 110. In some embodiments, the offer guidance generator 136 may be configured to respond to queries from the user U regarding the offer grade, the guidance, and the proposed offer 112. For example, if the guidance recommends adding an inspection contingency 117 to the proposed offer 112, the user U may ask for more details regarding the inspection contingency 117 and the consequences of not including the inspection contingency 117. The offer guidance generator 136 may generate a response to the query based on the offer grade, the guidance, the historical data (i.e., the listing data 142, the offer data 144, and the sale data 146), and the user preferences 148. In some embodiments, additional or alternative information may be used by the offer guidance generator 136. For example, the offer guidance generator 136 may use prewritten responses to frequently asked questions.

Based on the offer grade and the guidance, the user U may revise the proposed offer 112. The user U may then submit the revised offer to be evaluated by the offer negotiation engine 132 (e.g., repeating the process generally described above, until submission).

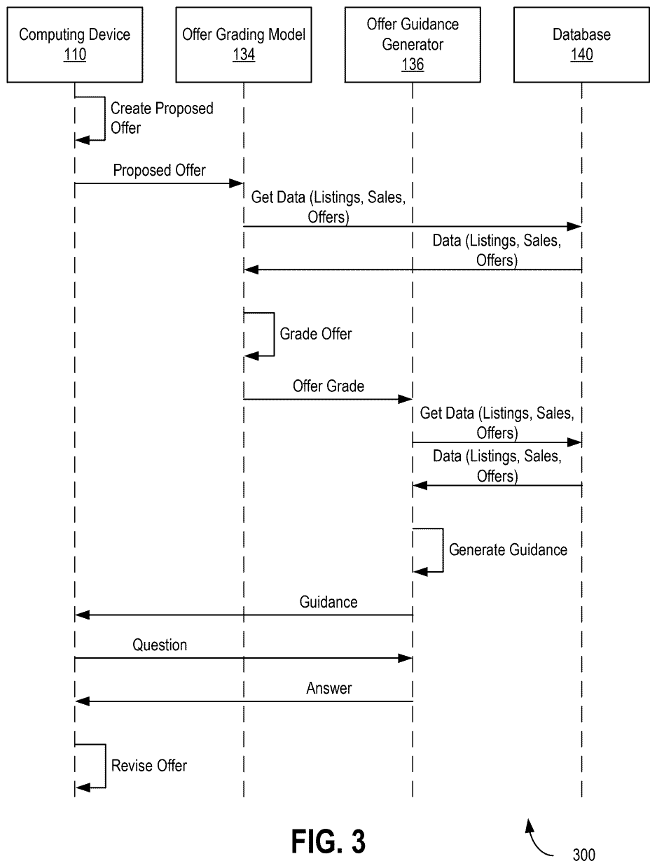

FIG. 3 illustrates an example message flow diagram 300 for providing offer grades and guidance. The illustrated example shows communications between a computing device 110, an offer grading model 134, an offer guidance generator 136, and a database 140. In an example, the offer grading model 134, the offer guidance generator 136, and the database 140 are part of an offer negotiation server, such as the server 130 described above in connection with FIG. 1.

In the example shown, a user creates a proposed offer at the computing device 110. In an embodiment, the user may manually enter information associated with the proposed offer, such as the terms of the offer. Manual entry of offer information may be accomplished by prompting the user to input terms in a web form, for example, which may be generated at the server 130 for display at a user computing device 110. In an alternative embodiment, the user may upload a document that represents the proposed offer, and the terms of the proposed offer may be extracted from the document. In an example, the user may create the proposed offer using a real estate application operating on the computing device. In an alternative example, the user may create the proposed offer using a real estate website separate from the server 130, to which the user connects via the computing device 110.

The proposed offer is transmitted to the offer grading model 134 to be graded. In an example, the offer grading model 134 grades the proposed offer based on historical data, such as listing data, offer data, and sale data. In an example, the historical data is associated with houses similar to the house for which the proposed offer applies, such as houses within the same geographical area. In an embodiment, the offer grading model 134 receives the historical data from the database 140.

In an embodiment, the offer grading model 134 is trained based on the historical data. In an example, the offer grading model 134 includes a Monte Carlo model, and distributions for input variable for the Monte Carlo model are learned by sampling the historical data. In alternative examples, the offer grading model may additionally or alternatively include any other statistical or machine learning models including neural networks, Markov chains, decision trees, linear regression models, and nearest neighbor models.

As noted above, the offer grading model 134 may include a plurality of different offer grading models. For example, different offer grading models may be used for different geographical regions, metropolitan areas, and the like, based on differences in offer acceptability. In such instances, training data may be selected from the historical data in accordance with the particular desired model. For example, training data for a Seattle metropolitan area may include offer and sale data from the same geographical area, at a minimum, and may extend through a historical period that may be representative of current market conditions (e.g., 3-6 months, or up to 2-3 years). Additionally, the training data may include a sampling of offer and sale data from other representative geographical areas (e.g., Portland, San Francisco, or other metro areas), particularly where the training data in the metro area itself may be sparse within an acceptable historical time period. In some instances, a proportion of localized to non-localized training data may be weighted to ensure accurate predictions (e.g., ensuring a baseline proportion of training data localized to the same metro area).

While the illustrated message flow diagram shows the offer grading model 134 receiving the data from the database 140 after receiving the proposed offer, in alternative embodiments, the offer grading model 134 may receive the data from the database 140 before receiving the proposed offer. For example, the offer grading model 134 may be trained on a periodic schedule (e.g., daily), so the offer grading model 134 may receive the data and be trained on the data before receiving the proposed offer. In some embodiments, the offer grading model 134 may still receive data from the database 140 after receiving the proposed offer even if the offer grading model 134 is trained on a period schedule. For example, in embodiments in which the offer grading model 134 includes a Monte Carlo model, data associated with the distributions of input variables for the Monte Carlo model may be stored in the database 140, and the offer grading model 134 may retrieve the distributions to grade the proposed offer when the proposed offer is received. Similarly, the offer grading model 134 may retrieve data from the database 140 to determine an estimated value of the home to which the proposed offer applies.

As described above, the offer grading model 134 may grade the proposed offer by calculating a probability that the proposed offer would be accepted. In an embodiment, the offer grading model 134 uses predetermined mappings to map the calculated probability to an offer grade. For example, if the calculated probability that the offer would be accepted is less than 40%, the offer grading model 134 may determine that the grade for the proposed offer is “risky.”

After grading the proposed offer, the offer grade is transmitted to the offer guidance generator 136, which generates guidance for the proposed offer. In an example, the guidance is based on the offer grade, the proposed offer, and historical data. In the illustrated example, the offer guidance generator retrieves the historical data from the database 140. In an embodiment, the historical data includes listing data, offer data, and sale data from similar homes to the home for which the proposed offer applies, such as homes in the same geographical area. In some embodiments, the offer guidance generator 136 additionally or alternatively uses user preferences when generating the guidance. In these embodiments, the user preferences may be retrieved from the database 140.

In an embodiment, the guidance includes a reasoning that explains the offer grade as well as recommendations to improve the strength of the offer. In an embodiment, the offer guidance generator 136 includes a large language model that processes the offer grade, the proposed offer, and the historical data to generate the guidance. In another example, the offer guidance generator 136 uses predefined rules to generate the guidance, as described above.

The guidance from the offer guidance generator 136 is transmitted to the computing device 110, and the guidance is presented to the user. In some embodiments, the user may have questions regarding the guidance, and the user may interact with the offer guidance generator 136 to answer the questions. Based on the guidance and any answers to questions submitted to the offer guidance generator 136, the user may revise the proposed offer. In an example, the user may submit the revised offer to be graded, which may follow a substantially similar process as described above.

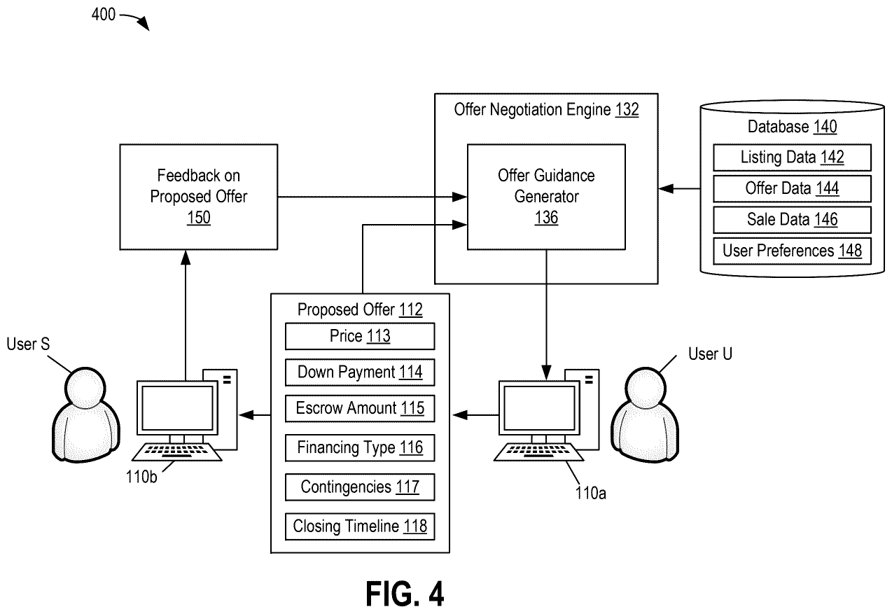

FIG. 4 illustrates an example system 400 for generating guidance for a proposed offer based on seller feedback. In the illustrated embodiment, the system 400 includes a plurality of computing devices 110 connected to an offer negotiation engine 132 including an offer guidance generator 136. In an example, the offer negotiation engine 132 operates on a server, such as the server 130 described above in connection with FIG. 1.

As described above, a user U (e.g., a potential buyer of a home) may create a proposed offer 112 to purchase the home at the computing device 110a. In the illustrated example, the proposed offer 112 includes an offer price 113, a down payment 114, an escrow amount 115, a financing type 116, contingencies 117, and a closing timeline 118. In embodiments, additional or alternative terms may be included in the proposed offer 112.

The proposed offer 112 may be transmitted to a user S (e.g., a seller of the home) at computing device 110b. The user S may reject the proposed offer 112, and the user S may provide feedback 150 on the proposed offer 112. For example, the user S may provide a counteroffer, or the user S may explain one or more reasons why the proposed offer 112 was rejected.

Based on the feedback 150 from the user S, the offer guidance generator 136 may generate guidance for the user U to improve the proposed offer 112. In an example, the offer guidance generator 136 includes a large language model to generate the guidance. In an alternative embodiment, the offer guidance generator 136 may additionally or alternatively use predetermined rules to generate guidance.

As described above, the offer guidance generator 136 may use historical data (e.g., listing data 142, offer data 144, and sale data 146) and user preferences 148 to generate the guidance for the user U. The offer guidance generator 136 may retrieve the historical data and the user preferences 148 from a database 140. In an example, unlike as described above, the offer guidance generator 136 may not use an offer grade to generate the guidance for the user U; the offer guidance generator 136 may know that the proposed offer 112 was rejected based on the feedback 150 from the user S. In an example, the offer guidance generator 136 may receive the feedback 150 directly from the user S. In an alternative example, the user S may transmit the feedback 150 to the user U, and the user U may provide the feedback 150 to the offer guidance generator 136.

In an example, the guidance generated by the offer guidance generator 136 may include a summary of the feedback 150 from the user S and recommendations for improving the proposed offer 112. For example, if the feedback 150 states that the offer price 113 is too low, the offer guidance generator 136 may recommend increasing the offer price 113. In an example, the offer guidance generator 136 may use the user preferences 148 (such as a stated budget of the user U) to recommend a new offer price 113. For example, a new offer price may be selected that increases the likelihood of acceptance by a predetermined amount (e.g., to above 50% likelihood, or an increase of 10-20% likelihood, or some similar thresholding) while remaining within other constraints, such as a stated or inferred budget, and using other offer terms selected by the user U. Like described above, the offer guidance generator 136 may be configured to respond to inquiries from the user U regarding the proposed offer 112, the feedback 150 from the user S, and the generated guidance.

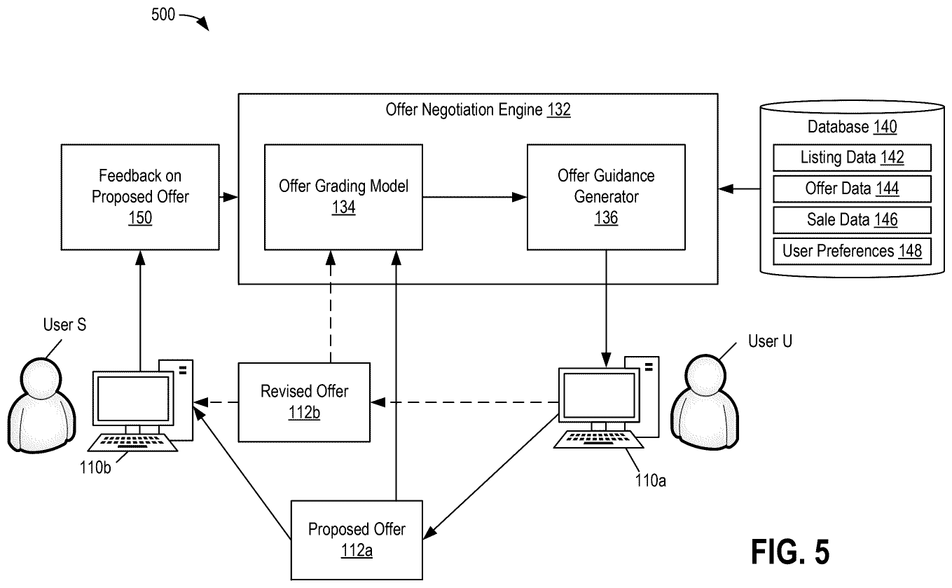

FIG. 5 illustrates an example system 500 for grading and providing guidance on a revised offer. In the illustrated embodiment, the system 500 includes a plurality of computing devices 110 connected to an offer negotiation engine 132. In an example, the offer negotiation engine 132 operates on a server, such as the server 130 described above in connection with FIG. 1.

As described above in connection with FIG. 4, a user U (e.g., a potential buyer of a home) may prepare a proposed offer 112a that is rejected by a user S (e.g., a seller of the home). The user S may provide feedback 150 on the proposed offer 112a. An offer guidance generator 136 may generate guidance for the user U to improve the proposed offer 112a based on the feedback 150 from the user S. Based on the guidance, the user U may create a revised offer 112b.

Like described above in connection with FIG. 2, the user U may submit the revised offer 112b to the offer negotiation engine 132 for grading and guidance. In an embodiment, an offer grading model 134 determines an offer grade for the revised offer 112b. In an embodiment, the offer grading model 134 includes a Monte Carlo model. As described above, the offer grading model 134 may generate the offer grade based on historical data (e.g., listing data 142, offer data 144, and sale data 146) maintained in a database 140.

In additional to the historical data, the offer grading model 134 may further consider the feedback 150 from the user S regarding the initial proposed offer 112a. For example, if the feedback 150 indicates that the offer price included in the initial proposed offer 112a is too low and the offer price is the same in the revised offer 112b, the offer grading model may decrease the offer grade for the revised offer 112b even if the historical data indicates that the revised offer 112b is a strong offer. In an embodiment, the offer negotiation engine 132 receives the feedback 150 directly from the user S. In an alternative embodiment, the user S transmits the feedback 150 to the user U, and the user U uploads the feedback 150 to the offer negotiation engine 132 along with the revised offer 112b.

As described above, the offer guidance generator 136 generates guidance regarding the revised offer 112b. For example, guidance may explain the offer grade determined by the offer grading model 134 and may include recommendations to increase the strength of the revised offer. Like previously described, the guidance may be based on the revised offer 112b, the offer grade, historical data (e.g., listing data 142, offer data 144, and sale data 146) and user preferences 148. In examples, the offer guidance generator 136 may further consider the feedback 150 from the user S regarding the initial proposed offer 112a. In an embodiment, the offer guidance generator 136 includes a large language model for generating the guidance. Additionally, in some embodiments, the offer guidance model 136 may be configured to respond to queries from the user U regarding the proposed offer 112a, the revised offer 112b, the offer grade, and the feedback 150 from the user S. The revised offer may then be provided to the user S for further feedback and/or acceptance, and further iterations may occur as needed to move toward acceptance.

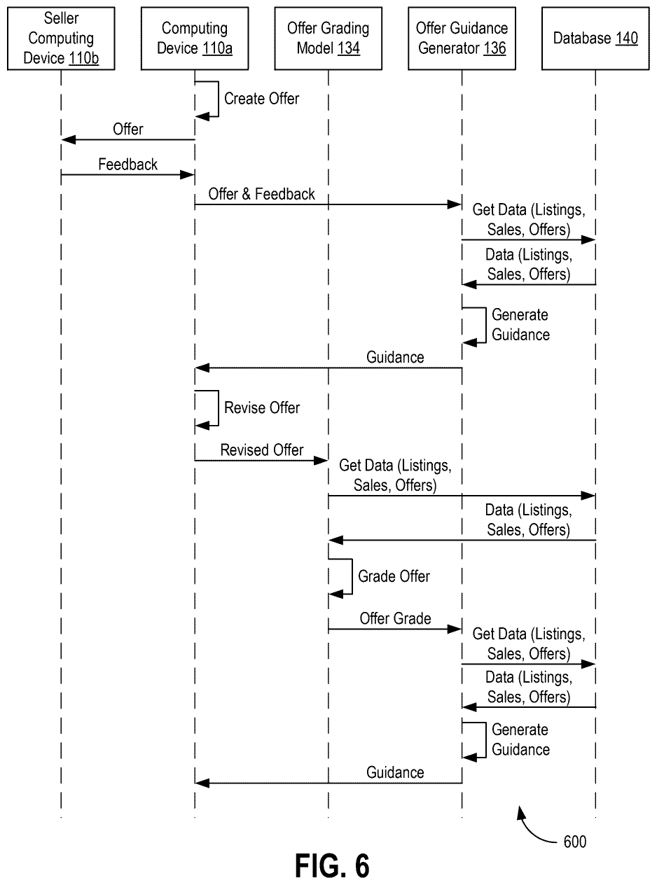

FIG. 6 illustrates an example message flow diagram 600 for providing guidance for an initial proposed offer based on feedback from a seller and grading a revised offer. The illustrated example shows communications between a computing device 110a, a seller computing device 110b, an offer grading model 134, an offer guidance generator 136, and a database 140. In an embodiment, the offer grading model 134, the offer guidance generator 136, and the database 140 are part of a server, such as the server 130 described above in connection with FIG. 1.

A user (e.g., a potential buyer of a home) creates an initial proposed offer at the computing device 110a and sends the offer to a seller at the seller computing device 110b. The seller may reject the offer and provide feedback to the user regarding the initial proposed offer. For example, the seller may indicate that the offer price is too low.

The proposed offer and the feedback are uploaded form the computing device 110a to the offer guidance generator 136. In an alternative embodiment, the offer guidance generator 136 may receive the feedback directly from the seller computing device 110b. As described above, the offer guidance generator 136 may generate guidance for the user based on the feedback from the seller. For example, the offer guidance generator 136 may summarize the feedback from the seller and provide recommendations for the user on ways to improve the proposed offer. In an embodiment, the offer guidance generator 136 includes a large language model.

In addition to the feedback from the seller, the offer guidance generator 136 may consider historical data (e.g., listing data, offer data, and sale data) and user preferences when generating the guidance for the user. In an embodiment, the offer guidance generator 136 retrieves the historical data and the user preferences from the database 140. The offer guidance generated may generate the guidance accordingly and transmit the guidance to the computing device 110a. Based on the guidance regarding the initial proposed offer, the user may revise the offer and submit the revised offer for grading and guidance.

As described above, the revised offer may be submitted to the offer grading model 134 for grading. In an example, the offer grading model 134 includes a Monte Carlo model. The offer grading model may determine a grade for the revised offer based on historical data (e.g., listing data, offer data, and sale data) and the feedback from the seller regarding the initial proposed offer. The offer grading model 134 may retrieve the historical data from the database 140.

While the illustrated message flow diagram shows the offer grading model 134 receiving the data from the database 140 after receiving the revised offer, in alternative embodiments, the offer grading model 134 may receive the data from the database 140 before receiving the revised offer. For example, as described above, the offer grading model 134 may be trained on a periodic schedule (e.g., daily), so the offer grading model 134 may receive the data and be trained on the data before receiving the revised offer. In some embodiments, the offer grading model 134 may still receive data from the database 140 after receiving the revised offer even if the offer grading model 134 is trained on a period schedule. For example, in embodiments in which the offer grading model 134 includes a Monte Carlo model, data associated with the distributions of input variables for the Monte Carlo model may be stored in the database 140, and the offer grading model 134 may retrieve the distributions to grade the revised offer when the proposed offer is received.

The offer grading model 134 grades the revised offer and transmits the offer grade to the offer guidance generator 136. As described above, the offer guidance generator 136 generates guidance for the user regarding the revised offer. In examples, the guidance includes reasoning for the offer grade and recommendations to improve the revised offer.

In an embodiment, the offer guidance generator 136 generates the guidance based on the offer grade, historical data, the revised offer, and the feedback from the seller. In an embodiment, the offer guidance generator 136 retrieves the historical data from the database 140. The guidance generated by the offer guidance generator 136 is transmitted to the computing device 110a and is presented to the user. In an example, the user may use the guidance to revise the revised offer.

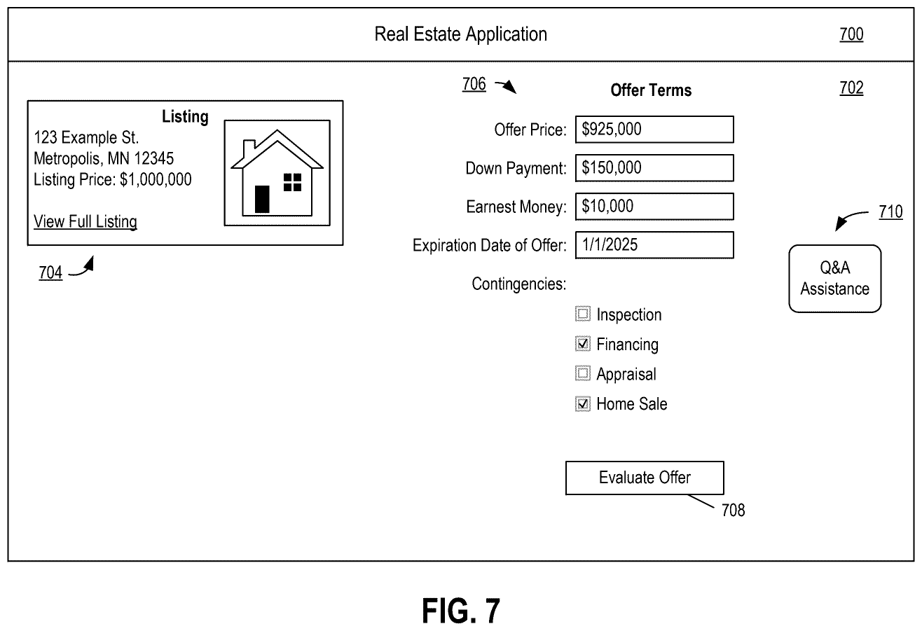

Turning to FIGS. 7-9, example user interfaces within a real estate application 700 are shown. In an example, the real estate application 700 may be executing on a computing device, such as the computing device 110 described above in connection with FIG. 1. In alternative embodiments, similar user interfaces may be presented in a browser connected to a real estate website.

FIG. 7 illustrates an example offer creation user interface 702. In an example, a user may use the offer creation user interface 702 to input information associated with an offer to purchase a home.

In the illustrated example, the offer creation user interface 702 includes listing information 704. The listing information 704 may include data associated with a listing for the home the user wishes to purchase. In the illustrated example, the listing information 704 includes an address of the home, a listing price of the home, an image of the home, and a link to view the full listing. In alternative embodiments, additional or alternative information may be presented with the listing information 704.

The offer creation user interface 702 additionally includes an offer input 706 through which the user can input data associated with a proposed offer, including the terms of the offer. In the illustrated example, the offer input 706 includes options to input an offer price, a down payment amount, an earnest money amount, an expiration date of the offer, and contingencies. In alternative embodiments, additional or alternative information about the proposed offer may be input, including a closing date, an escrow amount, a financing type, financing terms, warranties, proof of funds, and a pre-approval amount. In the illustrated example, the user may manually input information into the offer input 706. In alternative embodiments, the user may upload a document to the real estate application 700, and the terms of the offer may be automatically extracted from the document.

The offer creation user interface 702 additionally includes an option 710 to receive assistance. For example, the assistance may allow the user to ask questions regarding the terms of the offer, such as what the terms mean, and receive answers to the questions. In an example, an offer guidance generator responds to the questions from the user, such as the offer guidance generator 136 described above in connection with FIG. 2.

After all of the information is input at the offer input 706, the user may select an option 708 to evaluate the proposed offer. As described above, an offer grade may be determined for the proposed offer based on a probability that the proposed offer would be accepted. Additionally, guidance may be generated regarding the proposed offer, including recommendations to improve the proposed offer.

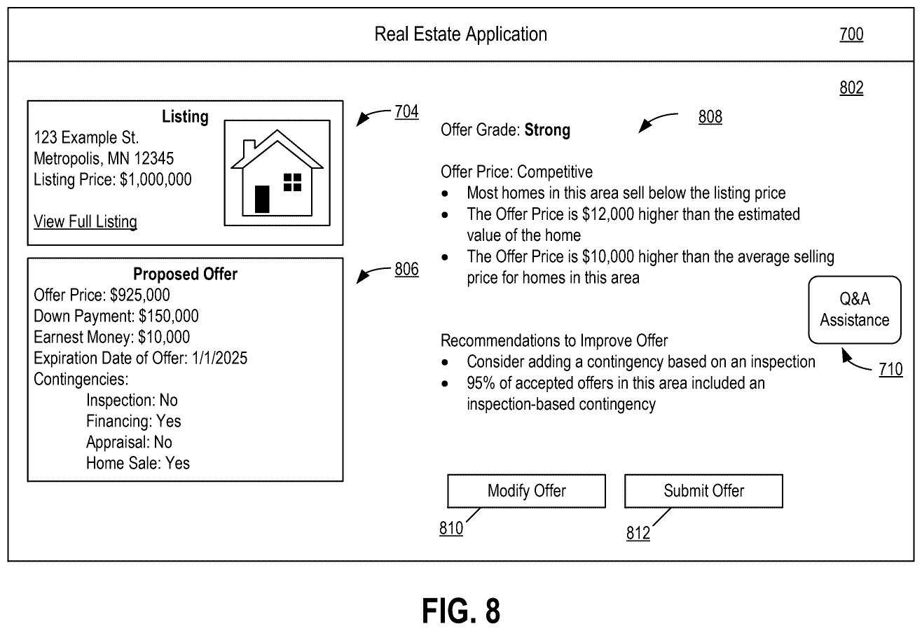

FIG. 8 illustrates an example offer guidance user interface 802. In the illustrated example, the offer guidance user interface 802 includes listing information 704 similar to the offer creation user interface 702 described above in connection with FIG. 7. The offer guidance user interface 802 further includes offer information 806. The offer information 806 includes the terms of the offer that were input at the offer creation user interface 702 described above and for which guidance was generated.

The offer guidance user interface 802 additionally includes guidance 808 regarding the proposed offer. In the illustrated example, the guidance includes an offer grade, reasoning for the offer grade, and recommendations to improve the proposed offer. In the illustrated example, the offer grade is strong, indicating that the proposed offer has a high probability of being accepted. The reasoning for the offer grade shown in the illustrated example explains that the offer price is competitive and provides statistics to justify the reasoning. In examples the statistics are based on historical data and an estimated value of the home.

In the illustrated example, in which the proposed offer has a high offer grade, the recommendations include suggestions to make the proposed offer more beneficial to the user without reducing the offer grade. In other examples, recommendations may include suggestions to increase the offer grade. The recommendation may also include reasoning to support the recommendation. In an example, the support for the recommendation may be based on historical data or calculations performed to determine the offer grade.

The recommendations to improve the proposed offer shown in the illustrated example include a recommendation to include an inspection-based contingency. The recommendation includes support for the recommendation based on a statistic showing that the vast majority of accepted offers in the geographic area include the recommended contingency. In some embodiments, the recommendation may further include a description of why the recommendation improves the offer.

In an embodiment, the guidance 808 may be generated by an offer grading model and an offer guidance generator, as described above. For example, the offer grading model may determine the offer grade for the proposed offer, and the offer guidance generator may generate the reasoning for the offer grade and the recommendations to improve the offer.

Like described above, the offer guidance user interface 802 may include an option 710 to receive assistance. For example, the assistance may allow the user to ask questions regarding the guidance, such as questions about the offer grade and the recommendations.

The offer guidance user interface 802 further includes options 810, 812 to modify the offer and submit the offer. For example, the user may choose to incorporate the recommendations proposed in the guidance 808. Accordingly, the user may select the option 810 to modify the offer. If the user is content with the proposed offer, the user may select the option 812 to submit the offer to the seller.

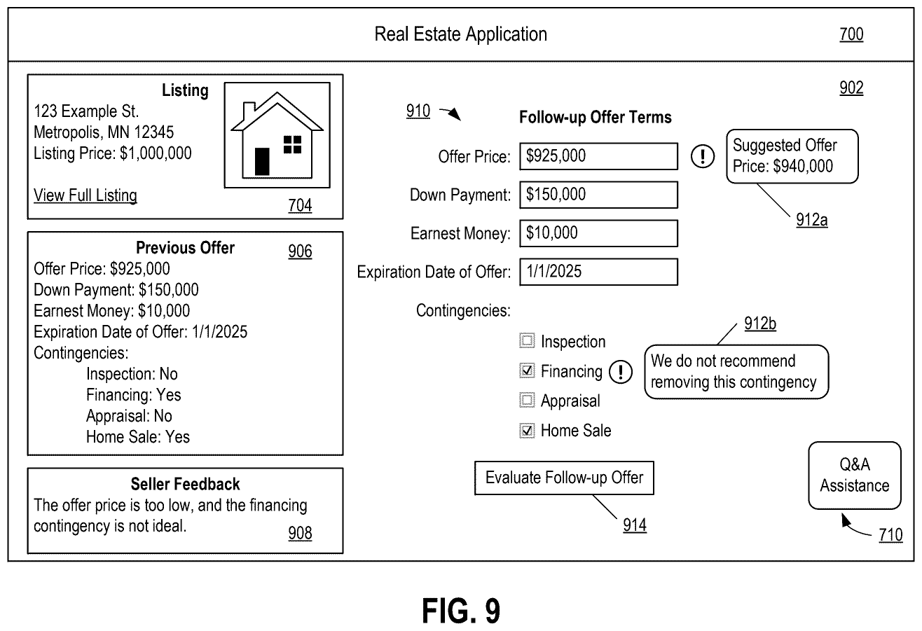

FIG. 9 illustrates an example offer revision user interface 902. In an example, after an offer is rejected by a seller, feedback from the seller may be received, and guidance to revise the offer may be generated.

In the illustrated embodiment, the offer revision user interface 902 includes listing information 704, as described above. The offer revision user interface 902 additionally includes the terms 906 of the previous offer that was rejected as well as feedback 908 from the seller regarding the rejected offer.

A revised offer input 910 allows the user to revise the terms 906 of the previous offer. In an embodiment, the revised offer input 910 defaults to the terms 906 of the previous offer and allows the user to edit the terms. In alternative embodiments, the terms in the revised offer input 910 are initially blank. In the illustrated example, the offer revision user interface 902 further includes recommendations 912 to improve the revised offer. In an example, the recommendations 912 are based on the seller feedback 908. For example, in the illustrated embodiment, the seller indicated that the offer price was too low (as shown in the seller feedback 908). Accordingly, the offer revision user interface 902 includes a recommendation 912a to increase the offer price. In an example, the recommendations 912 are further based on user preferences. For example, the user preferences may include a stated budget. In this example, the recommendation 912a may account for the user's budget and recommend a new offer price that is higher than in the previous offer but not higher than the user's budget.

In some examples, the recommendations 912 may suggest that the user does not change the offer as indicated by the seller. For example, in the illustrated embodiment, the seller indicated that the financing contingency is not ideal, but the recommendation 912b recommends keeping the financing contingency.

During the revision process, the user may select an option 710 to receive assistance. As described above, the assistance may allow the user to ask questions regarding the terms of the offer and the recommendations. The user may also be able to ask questions regarding the feedback 908 from the seller. Once the user has revised the terms of the offer, the user may select an option 914 to evaluate the revised offer.

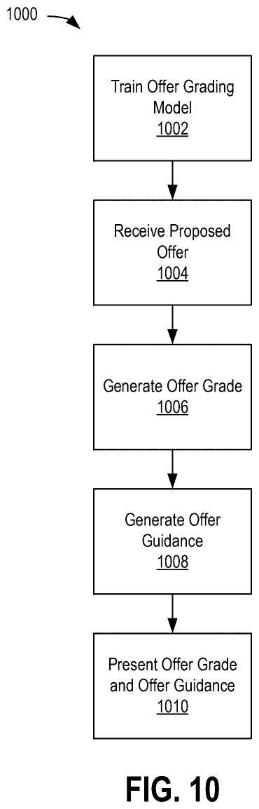

Turning to FIG. 10, a flowchart of an example method 1000 for evaluating an offer to purchase a home is shown. In the illustrated embodiment, the method 1000 includes operations 1002, 1004, 1006, 1008, 1010. In an example, the method 1000 is performed by an offer negotiation engine, such as the offer negotiation engine 132 described above in connection with FIG. 2.

The operation 1002 includes training an offer grading model. As described above, the offer grading model may be trained using historical data, such as listing data, offer data, and sale data. In an example, the offer grading model includes a Monte Carlo model, and training the Monte Carlo model includes determining distributions for input variables of the Monte Carlo model using the historical data. In example embodiments, the offer grading model is trained on a periodic schedule (e.g., daily).

The operation 1004 includes receiving a proposed offer. In an example, the proposed offer defines terms of an offer to purchase a home. For example, the proposed offer may define an offer price, a down payment, an amount of earnest money, an expiration date of the offer, contingencies, a closing date, an escrow amount, a financing type, financing terms, warranties, proof of funds, and a pre-approval amount. In an example, the proposed offer is received at the offer negotiation engine from a computing device executing a real estate application.

The operation 1006 includes generating an offer grade for the proposed offer. In an example, the offer grade is based on a calculated probability that the proposed offer would be accepted. For example, predefined mappings between probabilities and grades may be used to determine the offer grade. In an embodiment, the offer grading model determines the offer grade. In examples, the offer grading model may be trained using historical data, including listing data, offer data, and sale data. Once trained, the offer grading model may determine the offer grade based on terms of the proposed offer. In some embodiments, the offer grade may further be based on an estimated value of the home.

The operation 1008 includes generating guidance based on the offer grade. In an example, the guidance includes a reasoning for the offer grade and recommendations to improve the proposed offer. For example, the recommendations may include suggestions to increase the grade of the proposed offer. As described above, in an embodiment, the offer guidance is based on historical data, the offer grade, and user preferences. In an example, an offer guidance generator at the offer negotiation engine generates the offer guidance.

The operation 1010 includes presenting the offer grade and the offer guidance. In an example, as described above, the offer grade and the offer guidance are presented at a computing device via a user interface of a real estate application.

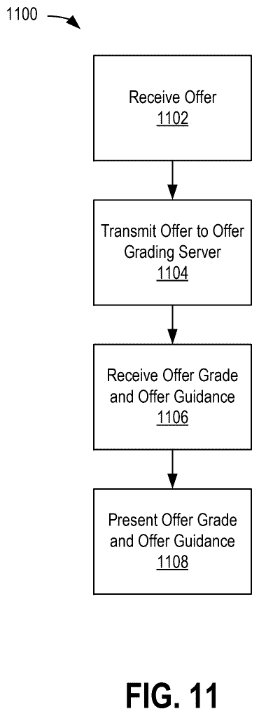

FIG. 11 illustrates a flowchart of an example method 1100 for presenting an offer grade and offer guidance to a user. In the illustrated example, the method 1100 includes operations 1102, 1104, 1106, 1108. In an example, the method 1100 may be performed by a user computing device, such as the computing device 110 described above in connection with FIG. 2.

The operation 1102 includes receiving an input defining an offer to purchase a home. In an example, a user may manually input terms included in the offer. In an alternative example, the user may upload a document including the offer, and terms of the offer may automatically be extracted from the document. In an embodiment, a user computing device receives the input defining the offer.

The operation 1104 includes transmitting the offer to an offer negotiation server. In an example, the offer negotiation server includes an offer grading model and an offer guidance generator. As described above, the offer grading model may be trained using historical data, such as listing data, offer data, and sale data. In an embodiment, a user computing device transmits the offer to the offer negotiation server over a network, such as the Internet.

The operation 1106 includes receiving an offer grade and offer guidance from the offer negotiation server. In an example, as described above, the offer grade is based on one or more terms in the offer. In embodiments, the offer guidance includes a reasoning for the offer grade and one or more recommendations to improve the offer. In an embodiment, a user computing device receives the offer grade and the offer guidance from the offer negotiation server over a network, such as the Internet.

The operation 1108 includes presenting the offer grade and the offer guidance. In an example, the offer grade and the offer guidance are presented in a user interface of a real estate application on a user computing device.

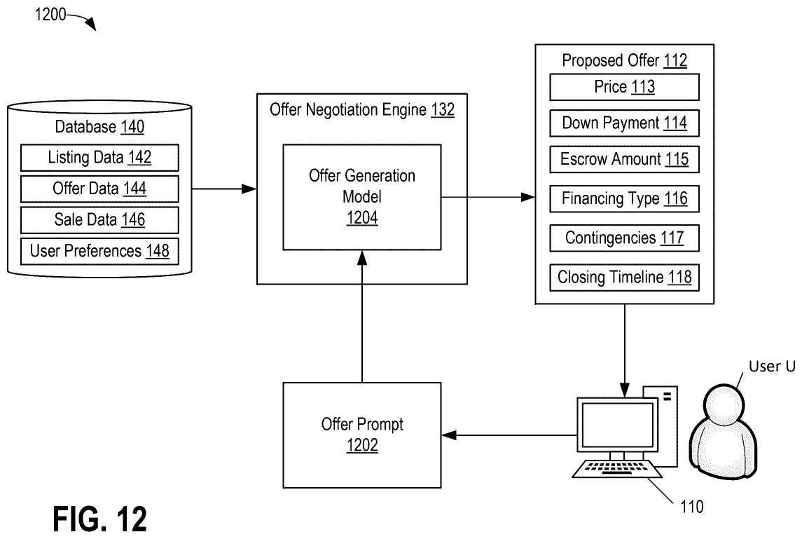

Turning to FIGS. 12-15, example embodiments for generating proposed offers are shown. FIG. 12 illustrates an example embodiment of a system 1200 for generating proposed offers. In the illustrated embodiment, a user U submits an offer prompt 1202 to an offer negotiation engine 132 from a computing device 110. Based on the offer prompt 1202, the offer negotiation engine 132 generates a proposed offer 112.

In example embodiments, the offer prompt 1202 includes one or more criteria on which the proposed offer 112 is generated. For example, the offer prompt 1202 may include a request to generate an offer that is competitive. In other examples, the offer prompt 1202 may include additional or alternative criteria. In an example, the offer prompt 1202 may request the strongest offer that includes one or more specified offer terms, such as contingencies 117.

In an embodiment, the user U inputs information associated with the offer prompt 1202 into the computing device 110. In an example, the computing device 110 may be executing a real estate application or may be connected to a real estate website operating on a server (such as the server 130 described above in connection with FIG. 1). In some examples, the user U may select from one or more predefined offer prompts 1202 presented on the computing device 110. In other examples, the user U may manually define the offer prompt 1202.

The offer prompt 1202 is transmitted from the computing device 110 to the offer negotiation engine 132, which generates the proposed offer 112. In an example, the offer negotiation engine 132 operates on an offer negotiation server, such as described above in connection with FIG. 1. In the illustrated example, the offer negotiation engine 1204 includes an offer generation model 1204.

The offer generation model 1204 generates a proposed offer 112 based on the offer prompt 1202. For example, the offer prompt 1202 may define criteria on which the offer generation model 1202 generates the proposed offer 112. In an example, the offer prompt 1202 may define a strength of the proposed offer 112. As described above, in some embodiments, the strength of the proposed offer 112 may be associated with a probability that the proposed offer 112 will be accepted—the probability of a risky offer being accepted may be less than 40%, the probability of a competitive offer being accepted may be between 40% and 60%, and the probability of a strong offer being accepted may be above 60%. Accordingly, if the offer prompt 1202 includes a request for a competitive offer, the offer generation model 1204 may generate a proposed offer 112 with an estimated probability of acceptance greater than 60%. In an example, the offer generation model 1204 may generate a proposed offer 112 with the lowest offer price that satisfies the criteria—i.e., when generating a strong offer, the proposed offer 112 may have the lowest offer price at which the estimated probability of acceptance is greater than 60%. While the above examples include offer strength as a criterion on which the offer generation model 1204 generate the proposed offer 112, in alternative examples, additional or alternative criteria may be considered by the offer negation model 1204.

In an embodiment, the offer generation model 1204 is trained using historical data, such as listing data 142, offer data 144, and sale data 146 from past transactions involving homes. In an embodiment, the listing data 142 includes data regarding homes that were listed for sale, such as the listing price. The offer data 144 may include data regarding offers to purchase the homes that were listed for sale. The sale data 146 may include data regarding the sales of the homes that were listed for sale, such as the terms of the offers that were accepted. In an embodiment, the historical data—i.e., the listing data 142, the offer data 144, and the sale data 146—is maintained in a database 140. In an example, the database 140 is maintained at a server, such as the offer negotiation server 130 described above in connection with FIG. 1.

In an example, the offer generation model 1204 includes a plurality of sub-models—for example, models trained for specific geographical locations or types of homes. For example, the offer generation model 1204 may include a model trained for a specific city. In this example, the model may be trained using historical data associated with the city. Similarly, in some examples, historical data from a predetermined time period (e.g., the previous year) is used to train the offer generation model 1204.

In an example embodiment, the offer generation model 1204 includes a Monte Carlo model. In an example, the Monte Carlo model performs simulations with one or more potential offers to determine the probability of acceptance of the potential offers. The potential offers may include terms that are determined by sampling from distributions set by the historical data—i.e., the listing data, offer data 144, and sale data 146. Examples of terms included in the potential offers include an offer price 113, a down payment 114, an escrow amount 115, a financing type 116, one or more contingencies 117, and a closing timeline 118. Additional or alternative terms may be included in alternative examples. In further examples, inputs to the Monte Carlo model may further include estimated statistics associated with the subject home, such as an estimated quantile of the sale price of the subject home and an estimated time until the subject home is sold. In examples, one or more of the estimated statistics may be generated by a trained model, such as a machine learning model or a statistical model, using the historical data. In an embodiment, the trained model may include an automated valuation model.

Based on the simulations with the one or more potential offers, the offer generation model 1204 may determine the proposed offer 112 to present to the user U. In an example, the proposed offer 112 may be selected from among the one or more potential offers based on estimated probabilities of acceptance of the one or more potential offers. For example, as described above, if the criterion defined by the offer prompt 1202 includes a request for a strong offer, the proposed offer 112 may be a potential offer for which the probability of acceptance was greater than 60%—e.g., the potential offer with the lowest offer price from among the potential offers with a probability of acceptance greater than 60%. The proposed offer 112 may be transmitted to the computing device 110 so that the proposed offer 112 can be presented to the user U.

In embodiments, user preferences 148 may also be used when generating the proposed offer 112. As described above, the user preferences 148 may include a budget of the user U. In examples, when generating the proposed offer 112, the offer generation model 1204 may generate a proposed offer 112 with an offer price 113 below the budget of the user U.

In some embodiments, the offer generation model 1302 may be the same model as the offer grading model 134 described above in connection with FIG. 2. Accordingly in some embodiments, the offer negotiation engine 132 may include a model configured to generate offer grades and generate proposed offers.

In alternative embodiments, the offer negotiation engine 132 may generate a portion of a proposed offer 112, rather than a full offer. For example, the offer negotiation engine 132 may generate a subset of terms to be included in a proposed offer 112. For example, the offer prompt 1202 may include a request for a strong offer price 113. Accordingly, the offer negotiation engine 132 may generate an offer price 113 for which the estimated probability of acceptance for an offer with the offer price 113 is greater than 60%.

Additionally, in embodiment, the offer negotiation engine 132 may include an offer guidance generator, such as the offer guidance generator 136 described above. In examples, the user U may have questions regarding the proposed offer 112. In these embodiments, the offer guidance generator may respond to user queries regarding the proposed offer 112. The offer guidance generator may similarly respond to any query from the user U regarding the offer generation process.

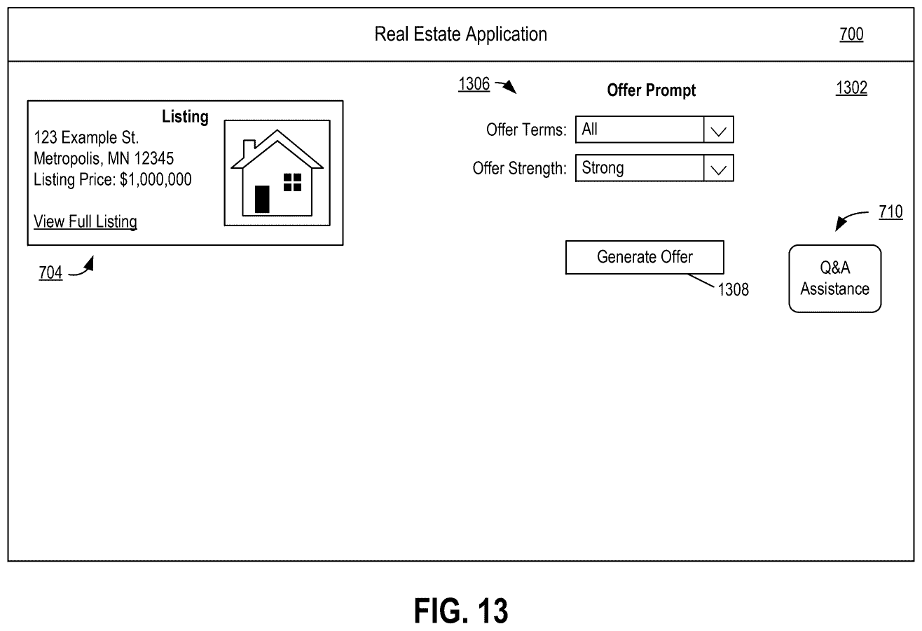

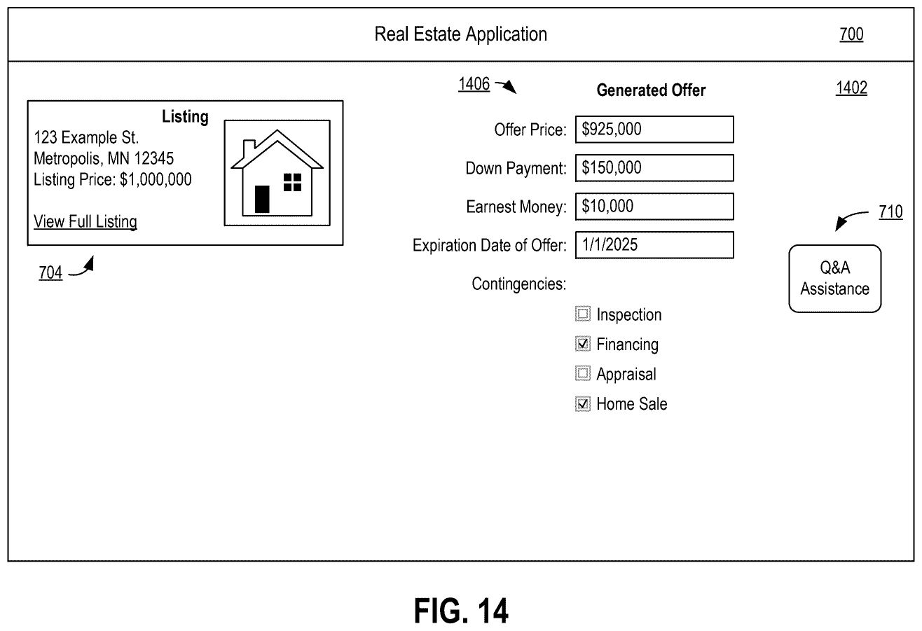

FIGS. 13 and 14 illustrate example user interfaces within a real estate application 700. In an example, the real estate application 700 may be executing on a computing device, such as the computing device 110 described above. In alternative embodiments, similar user interfaces may be presented in a browser connected to a real estate website.

FIG. 13 illustrates an example offer prompt user interface 1302. In an example, a user may use the offer prompt user interface 1302 to input an offer prompt to generate an offer to purchase a home.

In the illustrated example, the offer prompt user interface 1302 includes listing information 704. As described above, the listing information may include data associated with a listing for a home for sale that the user wishes to purchase. In the illustrated example, the listing information 704 includes an address of the home, a listing price of the home, an image of the home, and a link to view the full listing. In alternative embodiments, additional or alternative information may be presented with the listing information 704.

The offer prompt user interface 1302 additionally includes an offer prompt input 1306 through which a user may input data associated with an offer prompt. In the illustrated example, the user can select which terms should be included in the generated offer and a strength of the generated offer. In an example, the user may select from predefined options for the offer terms and the offer strength. In the illustrated example, the user may select that the generated offer to include all terms of the offer. In alternative examples, the user may select a subset of terms to be included in the generated offer—e.g., the user may request for just an offer price to be generated. In the illustrated example, the user may select that the generated offer to be strong. In alternative embodiments, additional or alternative options may be available to the user to construct the offer prompt. In further embodiments, the offer prompt user interface 1302 may include alternative input controls with which the user may input an offer prompt. For example, the offer prompt user interface 1302 may include an input through which the user may input a natural-language prompt for the offer prompt (e.g., “Generate a strong offer.”). After inputting information for the offer prompt, the user may select an option 1308 to generate an offer based on the offer prompt.

The offer prompt user interface 1302 may additionally include an option 710 to receive assistance. For example, the assistance may allow the user to ask questions regarding the offer prompt, such as what information to input. In an example an offer guidance generator, such as the offer guidance generator 136 described above, responds to the questions from the user.

FIG. 14 illustrates an example generated offer user interface 1402. In an example, after inputting an offer prompt, the generated offer user interface 1402 may present a proposed offer that was generated based on the offer prompt.

In the illustrated embodiment, the generated offer user interface 1402 may include listing information 704 similar to the listing information 704 described above. The generated offer user interface 1402 may further include a generated offer 1406. In embodiments, the generated offer 1406 includes terms specified by the offer prompt. In the illustrated example, the generated offer 1406 includes an offer price, a down payment, earnest money, an expiration date of the offer, and contingencies. In alternative embodiments, additional or alternative terms may be included in the generated offer. In further embodiments, a subset of terms may be included in the generated offer 1406—e.g., the generated offer 1406 may include just an offer price.

The generated offer user interface 1402 may additionally include an option 710 to receive assistance. For example, the assistance may allow the user to ask questions regarding the generated offer, such as such as asking for an explanation for how the offer terms were generated. As described above, an offer guidance generator may respond to the questions from the user.

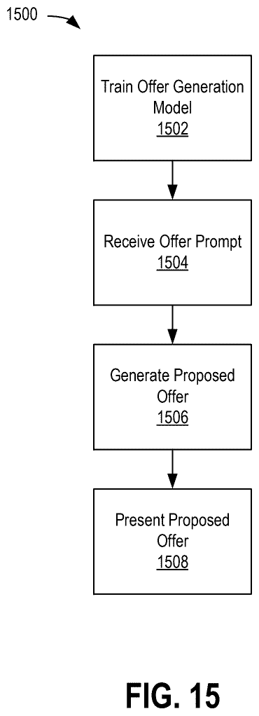

FIG. 15 illustrates a flowchart of an example method 1500 for generating a proposed offer. In the illustrated example, the method 1500 includes operations 1502, 1504, 1506, 1508. In an embodiment, an offer negotiation engine, such as the offer negotiation engine 152 described above, may perform the method 1500.

The operation 1502 includes training an offer generation model. As described above, the offer generation model may be trained using historical data, such as listing data, offer data, and sale data. In an example, the offer generation model includes a Monte Carlo model. In such the embodiment, training the Monte Carlo may include determining distributions for input variables of the Monte Carlo model, such as terms of potential offers, using the historical data. In example embodiments, the offer grading model is trained on a periodic schedule (e.g., daily).

The operation 1504 includes receiving an offer prompt. In an example, the offer prompt defines a criterion on which a proposed offer is generated. For example, the offer prompt may include a request for a strong offer. In some embodiments, the offer prompt may further define the terms to be included in the proposed offer. For example, the offer prompt may include a request for a full offer. In another example, the offer prompt may include a request for a subset of terms—i.e., the offer prompt may include a request for a strong offer price. In an example, the offer prompt is received at the offer negotiation engine from a computing device executing a real estate application.

The operation 1506 includes generating a proposed offer. In an example, the proposed offer is generated based on the offer prompt. In embodiments, the trained offer generation model generates the proposed offer. For example, a Monte Carlo model included in the offer generation model may perform simulations with one or more potential offers to determine estimated probabilities of acceptance of the one or more potential offers. The offer generation model may select the proposed offer from among the one or more potential offers based on the results of the simulations. For example, if the offer prompt included a request for a strong offer, the proposed offer may be selected from the one or more potential offers based on an estimated probability of acceptance being greater than 60%. In alternative examples, different one or more additional or alternative criteria may be considered when generating the proposed offer.

The operation 1508 includes presenting the proposed offer. In an example, the proposed offer is presented at a computing device via a user interface of a real estate application.

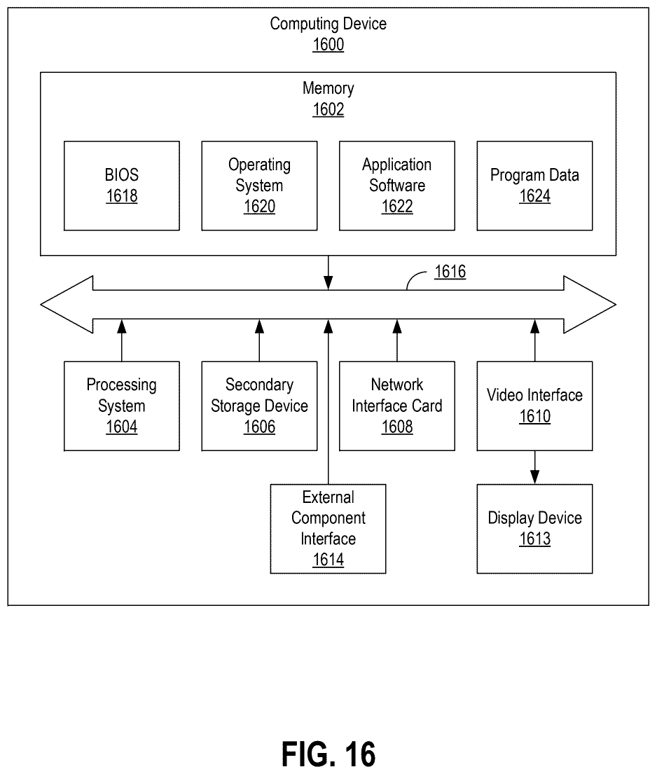

FIG. 16 illustrates an example computing device 1600 on which aspects of the present disclosure may be implemented. The computing device 1600 can be used, for example, to implement computing devices such as the computing device 110, the server 130, or any other computing device useable as described above in connection with FIG. 1.

In the example of FIG. 16, the computing device 1600 includes a memory 1602, a processing system 1604, a secondary storage device 1606, a network interface card 1608, a video interface 1610, a display unit 1613, an external component interface 1614, and a communication medium 1616. The memory 1602 includes one or more computer storage media capable of storing data and/or instructions. In different embodiments, the memory 1602 is implemented in different ways. For example, the memory 1602 can be implemented using various types of computer storage media, and generally includes at least some tangible media. In some embodiments, the memory 1602 is implemented using entirely non-transitory media.

The processing system 1604 includes one or more processing units, or programmable circuits. A processing unit is a physical device or article of manufacture comprising one or more integrated circuits that selectively execute software instructions. In various embodiments, the processing system 1604 is implemented in various ways. For example, the processing system 1604 can be implemented as one or more physical or logical processing cores. In another example, the processing system 1604 can include one or more separate microprocessors. In yet another example embodiment, the processing system 1604 can include an application-specific integrated circuit (ASIC) that provides specific functionality. In yet another example, the processing system 1604 provides specific functionality by using an ASIC and by executing computer-executable instructions.

The secondary storage device 1606 includes one or more computer storage media. The secondary storage device 1606 stores data and software instructions not directly accessible by the processing system 1604. In other words, the processing system 1604 performs an I/O operation to retrieve data and/or software instructions from the secondary storage device 1606. In various embodiments, the secondary storage device 1606 includes various types of computer storage media. For example, the secondary storage device 1606 can include one or more magnetic disks, magnetic tape drives, optical discs, solid-state memory devices, and/or other types of tangible computer storage media.

The network interface card 1608 enables the computing device 1600 to send data to and receive data from a communication network. In different embodiments, the network interface card 1608 is implemented in different ways. For example, the network interface card 1608 can be implemented as an Ethernet interface, a fiber optic network interface, a wireless network interface (e.g., WiFi, WiMax, Bluetooth, etc.), or another type of network interface.

In optional embodiments where included in the computing device 1600, the video interface 1610 enables the computing device 1600 to output video information to the display unit 1613. The display unit 1613 can be various types of devices for displaying video information, such as an LCD display panel, a plasma screen display panel, a touch-sensitive display panel, an LED or OLED screen, a cathode-ray tube display, or a projector. The video interface 1610 can communicate with the display unit 1613 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 1614 enables the computing device 1600 to communicate with external devices. For example, the external component interface 1614 can be a USB interface and/or another type of interface that enables the computing device 1600 to communicate with external devices or peripheral devices integrated within the same housing (e.g., in the case of mobile devices). In various embodiments, the external component interface 1614 enables the computing device 1600 to communicate with various external components, such as external storage devices, input devices, speakers, modems, media player docks, other computing devices, scanners, digital cameras, and fingerprint readers.

The communication medium 1616 facilitates communication among the hardware components of the computing device 1600. The communication medium 1616 facilitates communication among the memory 1602, the processing system 1604, the secondary storage device 1606, the network interface card 1608, the video interface 1610, and the external component interface 1614. The communication medium 1616 can be implemented in various ways. For example, the communication medium 1616 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, or another type of communications medium.

The memory 1602 stores various types of data and/or software instructions. The memory 1602 stores a Basic Input/Output System (BIOS) 1618 and an operating system 1620. The BIOS 1618 includes a set of computer-executable instructions that, when executed by the processing system 1604, cause the computing device 1600 to boot up. The operating system 1620 includes a set of computer-executable instructions that, when executed by the processing system 1604, cause the computing device 1600 to provide an operating system that coordinates the activities and sharing of resources of the computing device 1600. Furthermore, the memory 1602 stores application software 1622. The application software 1622 includes computer-executable instructions, that when executed by the processing system 1604, cause the computing device 1600 to provide one or more applications. In an example, the memory 1602 stores application software 1622 for a real estate application. The memory 1602 also stores program data 1624. The program data 1624 is data used by programs that execute on the computing device 1600.

Although particular features are discussed herein as included within an electronic computing device 1600, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include various types of dynamic random access memory (DRAM), solid state memory, read-only memory (ROM), electrically-erasable programmable ROM, magnetic disks (e.g., hard disks, floppy disks, etc.), and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

It is noted that, in some embodiments of the computing device 1600 of FIG. 16, the computer-readable instructions are stored on devices that include non-transitory media. In particular embodiments, the computer-readable instructions are stored on entirely non-transitory media.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A method for evaluating an offer to purchase a home, the method comprising:
training an offer grading model based on historical data, the historical data including listing data, offer data, and sale data;
receiving a proposed offer including at least one term of an offer to purchase a home, wherein the proposed offer is input via a user interface presented at a computing device; and
in response to receiving the proposed offer:
generating, using the trained offer grading model, an offer grade based on the proposed offer;
based on the offer grade and the proposed offer, generating guidance on the proposed offer; and
causing the user interface presented at the computing device to present the offer grade and the generated guidance.

2. The method of claim 1, wherein the offer grade is based on a probability of acceptance of the offer to purchase the home.

3. The method of claim 1, wherein the offer grading model includes a Monte Carlo model, and
wherein training the offer grading model includes determining a distribution for an input variable for the Monte Carlo model.

4. The method of claim 1, wherein the guidance includes a recommendation to improve the proposed offer.

5. The method of claim 1, wherein the guidance includes a reasoning explaining the offer grade.

6. The method of claim 1, further comprising:
receiving a user query associated with the guidance; and
generating a response based on the proposed offer, the offer grade, and the guidance.

7. The method of claim 1, wherein the offer grade is further based on feedback associated with a rejected offer.

8. The method of claim 1, wherein the historical data is associated with homes in a geographical area.

9. The method of claim 1, wherein a large language model generates the guidance on the proposed offer.

10. The method of claim 1, wherein the guidance is generated based on a predetermined set of rules.

11. The method of claim 1, further comprising:
receiving an offer prompt, the offer prompt defining a criterion for a generated offer;
generating the generated offer based on the offer prompt, wherein the generated offer satisfies the criterion defined by the offer prompt; and
causing the user interface presented at the computing device to present the generated offer.

12. A system for evaluating an offer to purchase a home, the system comprising:
one or more processors; and
one or more computer-readable storage devices storing data instructions that, when executed by the one or more processors, cause the system to:
train an offer grading model based on historical data, the historical data including listing data, offer data, and sale data;
receive a proposed offer including at least one term of an offer to purchase a home, wherein the proposed offer is input via a user interface presented at a computing device; and
in response to receiving the proposed offer:
generate, using the trained offer grading model, an offer grade based on the proposed offer;
based on the offer grade and the proposed offer, generate guidance on the proposed offer; and
cause the user interface presented at the computing device to present the offer grade and the generated guidance.

13. The system of claim 12, wherein the offer grade is based on a probability of acceptance of the proposed offer.

14. The system of claim 12, wherein the offer grading model includes a Monte Carlo model, and
wherein to train the offer grading model includes to determine a distribution for an input variable for the Monte Carlo model.

15. The system of claim 12, wherein the guidance includes a recommendation to improve the proposed offer and a reasoning explaining the offer grade.

16. A method for evaluating an offer to purchase a home, the method comprising:
receiving an input defining an offer to purchase a home, the offer including one or more terms;
transmitting the offer to an offer negotiation server, the offer negotiation server including a trained offer grading model and an offer guidance generator, wherein the offer grading model is trained based on historical data including listing data, offer data, and sale data;
receiving, from the offer negotiation server, an offer grade and guidance associated with the offer, wherein the offer grade is determined by the offer grading model based on the one or more terms, and wherein the guidance is generated by the offer guidance generator; and
presenting, via a user interface, the offer grade and the guidance.

17. The method of claim 16, further comprising:
receiving an input defining a revised offer to purchase the home;
transmitting the revised offer to the offer negotiation server; and
receiving, from the offer negotiation server, a revised offer grade and updated guidance.

18. The method of claim 17, further comprising:
transmitting the offer to a seller of the home; and
receiving, from the seller, feedback associated with the offer,
wherein the revised offer is based on the feedback from the seller,
wherein the feedback is transmitted to the offer negotiation server, and
wherein the revised offer grade and the updated guidance are based on the feedback.

19. The method of claim 16, further comprising:
transmitting, to the offer negotiation server, a query associated with the guidance;
and
receiving, from the offer negotiation server, a response to the query.

20. The method of claim 16, wherein the offer grade is further based on one or more user preferences.
